(19) United States
(12) Patent Application Publication
(10) Pub. No.: US 2013/0194317 A1
(43) Pub. Date: Aug. 1, 2013

(54) SYSTEM AND METHOD

(71) Applicants: Michel Lucien Guillon, St.Laurence (JE); Cecile-Adrienne Maissa, London (GB)

(72) Inventors: Michel Lucien Guillon, St.Laurence (JE); Cecile-Adrienne Maissa, London (GB)

(21) Appl. No.: 13/695,421

(22) PCT Filed: Apr. 27, 2011
(86) PCT No.: PCT/GB2011/050838

§ 371 Date: Mar. 15, 2013

(30) Foreign Application Priority Data
Apr. 30, 2010 (GB) 1007267.6

(51) Int. Cl. G09G 3/00

(52) U.S. Cl. CPC G09G 3/006
USPC 345/690

(57) ABSTRACT

A method of operating a data processing apparatus for testing visual acuity and/or visual contrast, the method comprising displaying symbols on a display device, the symbols displayed having luminance, colour and contrast, varying the luminance, colour and/or contrast or any one or combination of luminance, colour and/or contrast of the symbols displayed on the display device; and varying the time period for displaying the symbols.

The present invention relates to an ocular testing system and method. In particular, it relates to a system and method for visual acuity testing and/or visual contrast testing.

Conventional systems for testing visual acuity are the so-called visual acuity charts. Visual acuity charts typically consist of visual information such as black symbols, for example alphanumeric characters, on a white background. The use of black symbols on a white background is believed to provide maximum contrast for the symbols under test conditions.

In a development of visual acuity charts, known measurement systems for use in visual acuity tests control the luminance and the contrast of the visual acuity chart in order to produce testing routines more relevant to everyday visual tasks such as computer tasks displayed on a computer monitor. Such routines are more sensitive to detecting differences between correction modalities than conventional high contrast visual acuity charts. Such systems provide an improved measure of visual acuity when compared to visual acuity charts however they fail to achieve a good correlation between the visual acuity measured and visual satisfaction.

However, the known systems suffer from various problems. For example, known systems do not take account of a temporal element in the test routine. That is, the known systems allow the test to be performed over an indefinite time which does not provide an accurate indication of the ability to rapidly acquire and interpret visual information. The ability to acquire and interpret visual information rapidly is known as functional vision.

Furthermore, standard pre-printed acuity charts cannot measure visual acuity in terms of contrast sensitivity. Computerised versions of acuity charts which involve psychometric tests can be used to measure contrast sensitivity. However, such computerised versions are not considered suitable for general practice or large test sample use. In the case of pre-printed acuity charts and computerised versions they both lack the ability to control a temporal element in the contrast sensitivity test routine.

A further problem with visual acuity charts is the so-called learning effect. Over repeated tests the specific location and order of symbols on the visual acuity chart may be remembered deliberately or subliminally such that the test results cease to become an accurate indication of visual acuity.

A yet further problem with visual acuity chart tests is the fact that they are limited to black or grey symbols on a white background. Such tests therefore fail take account of chromatic effects or colour perception in testing visual acuity.

The present invention seeks to provide a system and method which overcome the above mentioned problems. It seeks to provide system and method which can be used easily by users with basic familiarity with conventional visual acuity measurements. It also seeks to provide a system and method which allows for rapidity of use which allows the system and method to be easily incorporated in routine visual acuity tests when necessary. Yet further, the present invention seeks to provide a method and system for visual acuity testing and/or visual contrast testing with high sensitivity to detect differences between modalities of corrections. The system and methods according to the present invention therefore provide visual acuity tests and/or visual contrast tests in which the test conditions resemble everyday visual tasks.

Thus according to a first aspect of the present invention there is provided a method of operating a data processing apparatus for testing visual acuity and/or visual contrast, the method comprising displaying symbols on a display device, the symbols displayed having luminance, colour and contrast; varying the luminance, colour and/or contrast or any one or combination of luminance, colour and/or contrast of the symbols displayed on the display device; and varying the time period for displaying the symbols.

In one arrangement, the time period for displaying the symbols that is varied is the period for which the symbols are displayed on the display device. In one alternative arrangement, the time period for displaying the symbols that is varied is the period between display of successive symbols on the display means.

Any suitable display means can be used. In one arrangement, the display means is a conventional computer monitor.

The method of the present invention therefore provides a temporal element in the acuity test and/or the contrast test. The time period can be varied between an off state and a permanently on state. Preferably the time period will be in the order of several hundreds of milliseconds. More preferably still the time period will be 300 ms.

By the present invention the problems associated with the problems of the prior art arrangements are addressed. Further the method and system is convenient to operate and may be operated by untrained people who are simply familiar with visual acuity measurement with a letter chart.

The luminance, colour and contrast of the symbols can be varied to represent environmental conditions. For example, environmental conditions can be one of or any combination of daytime, night time, indoor and/or outdoor conditions.

A high luminance can be produced by a bright monitor display, for example greater than 1000 cd/m². A low luminance can be produced by a dim monitor display, for example less than 2.5 cd/m². Luminance can be varied by an output signal from the data processing apparatus, or by neutral density filters placed on the monitor or in apparatus such as glasses or goggles worn by the person being tested. In a preferred embodiment a luminance of 250 cd/m² represents daytime environmental conditions, 50 cd/m² represents indoor environmental conditions and 2.5 cd/m² represents night time environmental conditions.

The contrast can be varied by any suitable amount. In one arrangement it may be varied from 99.9% to 0.1% to represent the range of contrasts encountered in everyday life. Preferably the range of contrast can be varied from 90% to 10%. The ability to vary the contrast means that contrast sensitivity tests can be carried out over a range of contrasts encountered in everyday life.

The colour of the symbols can be varied in the spectral range of visual wavelengths. This allows for testing of coloured lenses or filters for use in a specific environment. For example, some manufacturers are claiming the beneficial effect of a specific filter for a specific sport; however to date the selection of such filters is empirical and not based upon measurements on users. This colour testing allows for the production of identical test charts to the black and white or grey and white acuity test charts where the white background is replaced by the background against which the symbol of interest needs to be detected by a user.

One example of this arrangement relates to the detection of a cricket ball against a sky background for an outfielder (e.g.: red ball vs. grey sky or blue sky) or the detection of a cricket ball against a grass background for an infielder (e.g. a red or white cricket ball against a green background).

A second example is the detection of a target against specific backgrounds for clay pigeon shooters (e.g. a test that matches the colour of the clay vs. any background of relevance).

In a further example, the reading of the green in golf by increasing the contrast between different hues of green the player is able to better read the slope and inclination of the green, hence the target and background are representative of the colours of the golf course green.

A still further example relates to the detection of any target for a specific environment in a recreational or industrial setting.

The testing of coloured lenses or filters allows the determination of the best filter for either a general application for mass product production or the determination of the best filter for a specific person who may or may not be colour defective.

In addition to the colour of the symbols being varied, the symbols may be poly-chromatic. That is to say they may be patterned.

As indicated above, a background on which the symbol is displayed can be varied to represent specific environmental conditions such as recreational, domestic or industrial scenarios. As with the symbols the choice of background is entirely at the choice of the user.

Environmental scenarios such as driving, playing sport and so forth can also be represented. Environmental scenarios can be represented by selecting appropriate symbols and backgrounds. The choice of symbols is entirely at the choice of the user and can include alphanumeric symbols, optotypes or images of everyday objects. Optotypes can include but are not limited to letters, Landolt rings, tumbling Es and so on. Images can include, but are not limited to for example sports balls, such a golf ball or a football, or clay pigeons. Where images are to be used, they may be obtained by any suitable means such as from a digital camera.

The different symbols will preferably be displayed randomly thus preventing the user from learning specific sequences of symbols displayed.

In one arrangement one symbol may be displayed at a time. However, more than one symbol can be displayed at the same time. Where a plurality of symbols is displayed at the same time, they may remain on the display for the same length or different periods of time. The method can also vary the size of the symbols displayed on the display means.

The method is applicable at all test distances from near to far, and is particularly useful when testing presbyopes.

According to a second aspect of the present invention there is provided a system for testing visual acuity and/or visual contrast, the system comprising a data processing apparatus and a display device, the data processing apparatus configured to display symbols on the display device, the symbols displayed having luminance, colour and contrast; wherein said luminance, colour and/or contrast or any one or combination of luminance, colour and/or contrast of the symbols when displayed on said display device can be varied; and the time period for displaying the symbols can be varied.

Details of the system are as described above in connection with the first aspect of the present invention.

According to a third aspect of the present invention there is provided a method of testing visual acuity and/or visual contrast, the method comprising displaying symbols on a display device of a data processing apparatus, the symbols displayed having luminance, colour and contrast, varying the luminance, colour and/or contrast or any one or combination of luminance, colour and/or contrast of the symbols displayed on the monitor; and varying the time period for displaying the symbols; and observing a patient response to the varying luminance, colour and/or contrast and the varying time period.

Details of the method are as described above in connection with the first aspect of the present invention

The system and testing method of the present invention can be carried out over a short period of time and therefore it can be incorporated into busy practices.

The methods and systems of the present invention have high sensitivity to detect differences between modalities of corrections which are superior to current testing systems.

A further benefit is that the system may be of relatively low cost.

The method, system and method of testing can be implemented on any suitable device. Generally it will be implemented on a standard personal computer or mobile device and will generally be compatible with standard operating systems, such as, for example, Windows XP®.

The methods or system can be implemented modularly at the choice of the user. For example a basic module can be incorporated in routine practice computerised vision chart system software.

Any suitable display device can be used. Generally a standard TFT LCD screen will be used. A self-calibration system may be provided.

A clinical trial module can be incorporated into any multi-site assessment requiring precise vision measurement (e.g. improved optics contact lens, IOL, advanced spectacle design, etc.). A vision research module can be used in early development of vision correction products to achieve high testing sensitivity when testing early prototype (Phase 1 or 2) on relatively small number of subjects. A sports vision module modified to deal with the requirement of specific sports may also be provided.

The invention can be implemented at relatively low cost to the user depending upon the level of sophistication required. For general use standardised computer equipment can be used. For more specific applications (e.g. need for very bright environment) specialist monitor may be required. Depending on the end use, the monitor may be a 17 inch display with a native resolution of 1280×1024. Preferably the method is enabled to calibrate the monitor used for testing.

The method and system can be implemented in one arrangement in a static assessment mode and/or a time control assessment mode. Static assessments can include visual acuity tests and contrast tests. Time control assessments may include time controlled visual acuity tests and dynamic vision threshold tests.

The invention can also be implemented as synchronised combination of more than one test. In everyday life it is often necessary to change the direction of gaze (e.g. looking straight then up or down) and rapidly gather visual information or to look rapidly and alternatively at near and distance. The invention can therefore combine two or more such systems and methods to reproduce any required environmental visual scenario.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

According to a fourth aspect of the present invention there is provided a program for a computer arranged to implement the method or system of the above aspects of the present invention.

Suitably, the computer program is stored on a carrier medium in machine readable form, for example the carrier medium may comprise memory, removable or non-removable media, erasable or non-erasable media, writeable or re-writeable media, digital or analogue media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identify module, tape, cassette solid-state memory. The computer program may be supplied from a remote source embodied in the communications medium such as an electronic signal, radio frequency carrier wave or optical carrier waves. Such carrier media are also envisaged as aspects of the present invention.

The present invention will now be described, by way of example, with reference to the accompanying drawings in which:

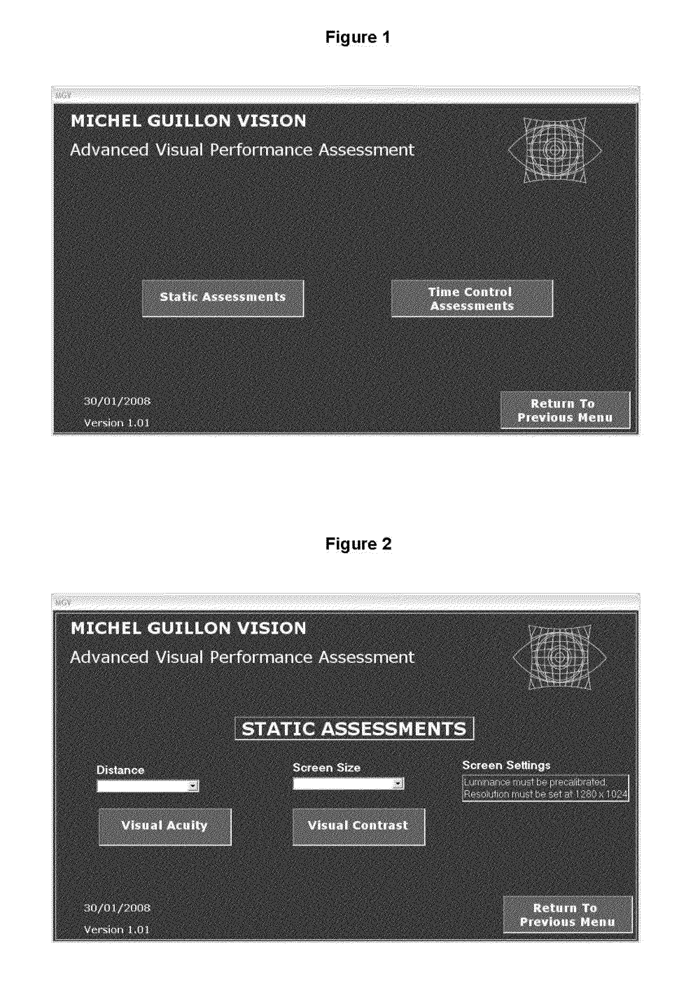

FIG. 1 is a screen shot of a typical first page of the one example of the system;

FIG. 2 is a screen shot of a typical second page of one example of the system;

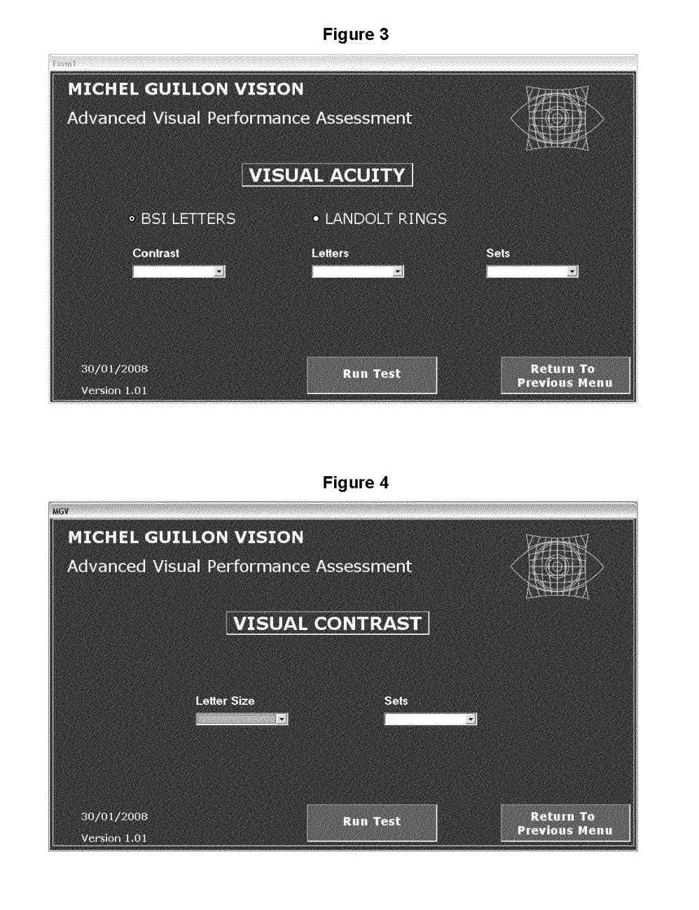

FIG. 3 is a screen shot of a typical third page of one example of the system;

FIG. 4 is a screen shot of a typical fourth page of one example of the system;

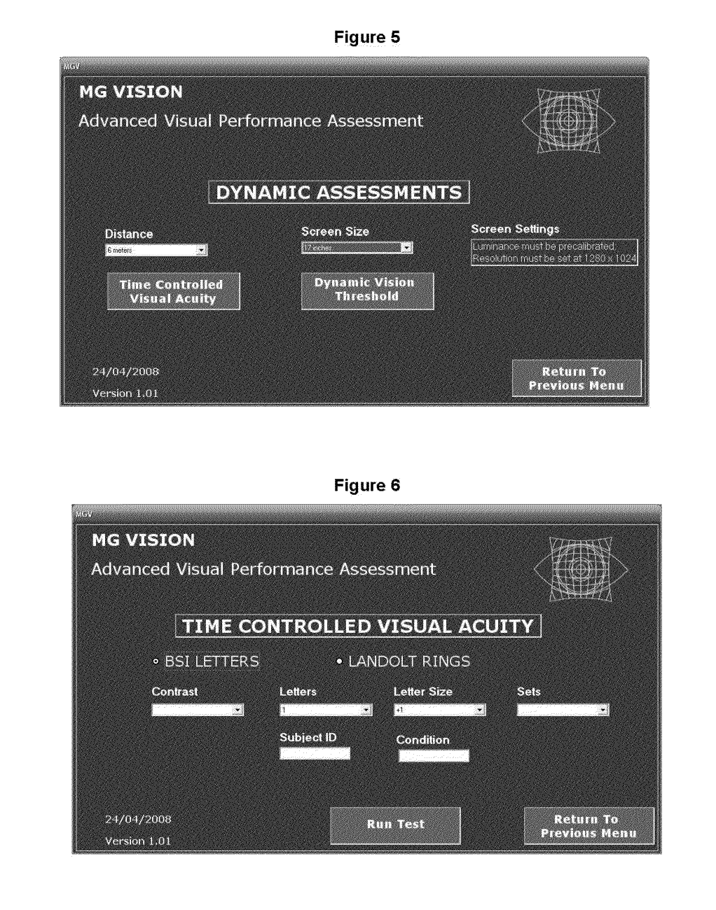

FIG. 5 is a screen shot of a typical fifth page of one example of the system;

FIG. 6 is a screen shot of a typical sixth page of one example of the system;

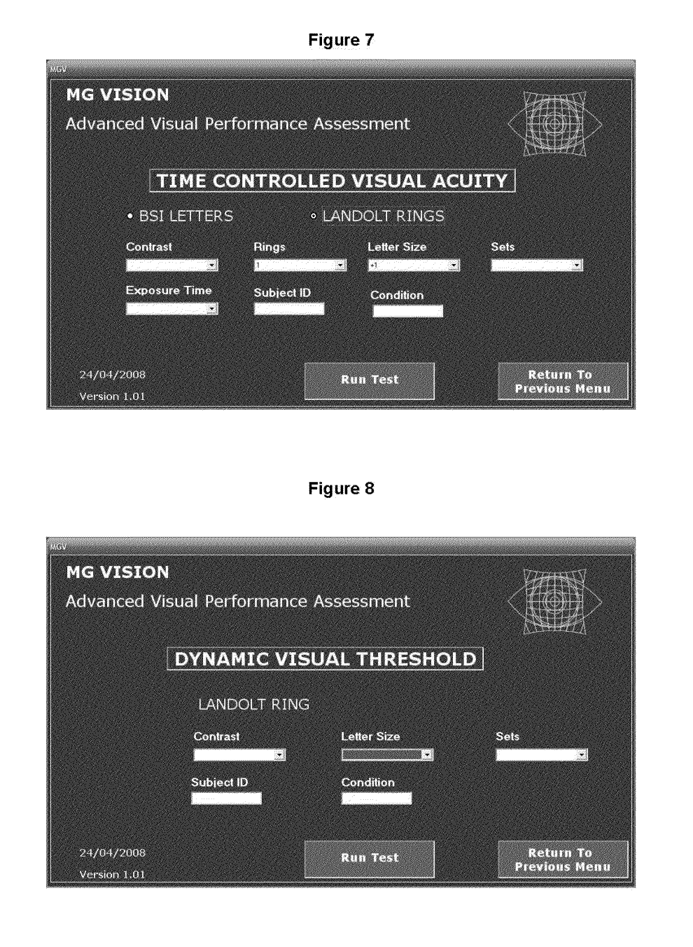

FIG. 7 is a screen shot of a typical seventh page of one example of the system;

FIG. 8 is a screen shot of a typical eighth page of one example of the system;

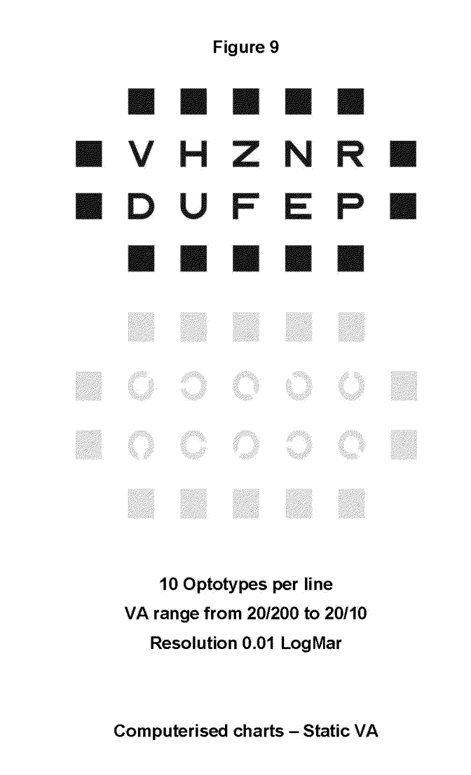

FIG. 9 is the computerised charts—static VA used in the Example;

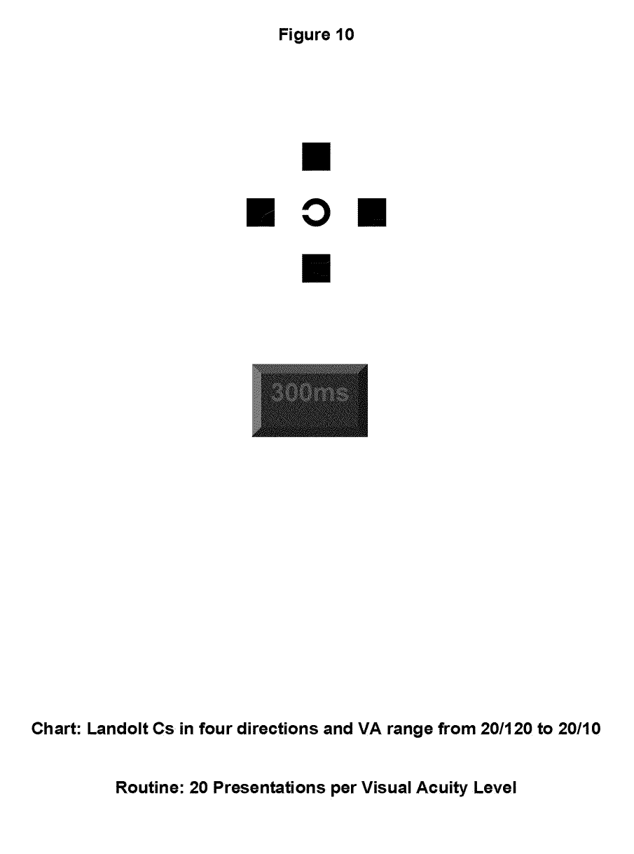

FIG. 10 is the computerised charts—time controlled VA used in the Example;

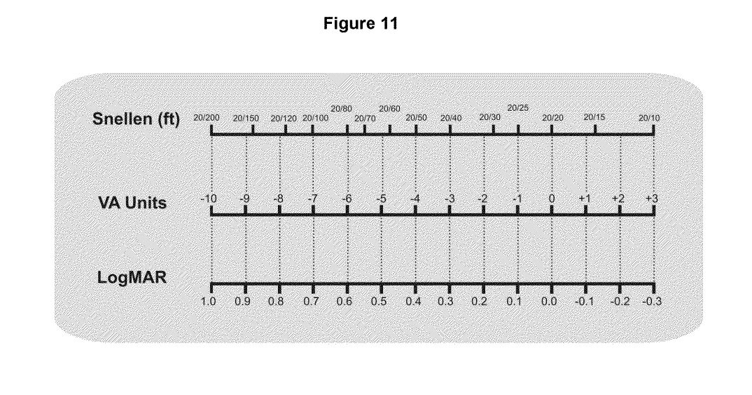

FIG. 11 is the Visual Acuity Recording Scales used in the Example;

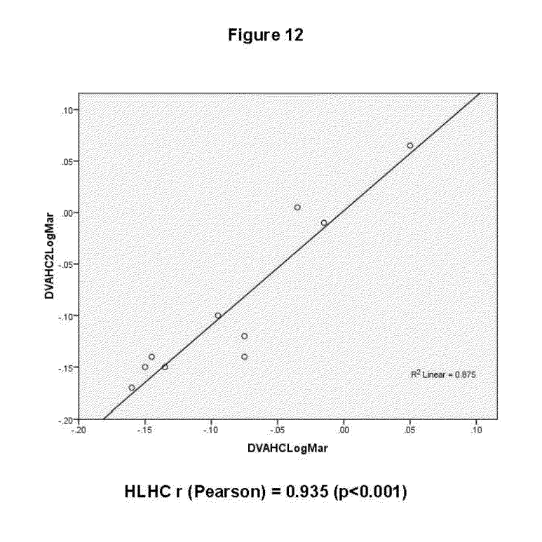

FIG. 12 is a graph illustrating the correlation V1 vs V2 for HLHC VA;

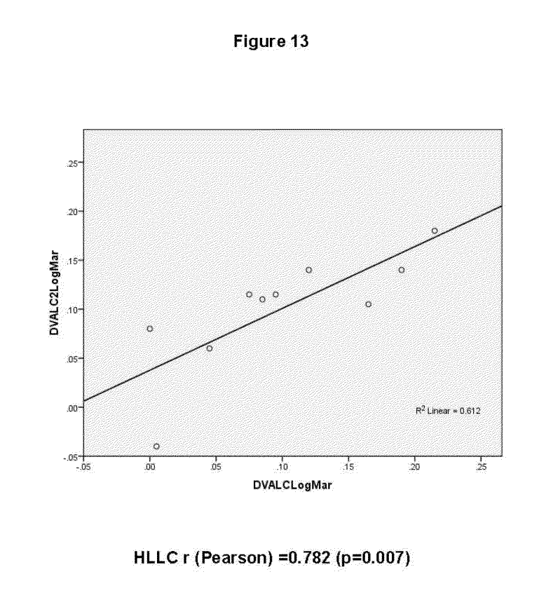

FIG. 13 is a graph illustrating the correlation V1 vs V2 for HLLC VA;

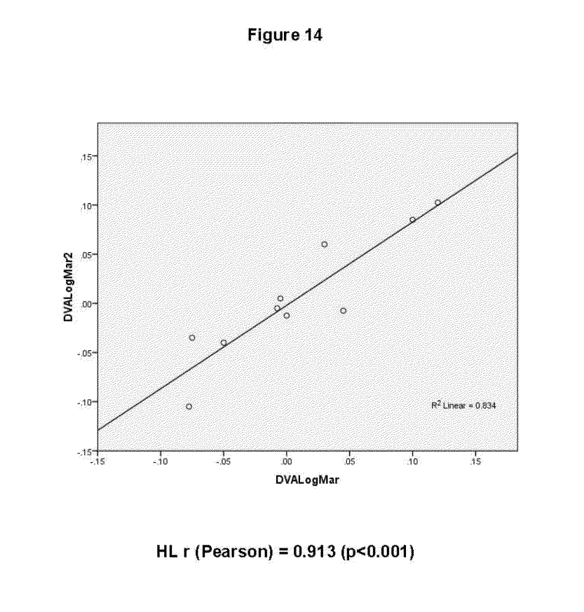

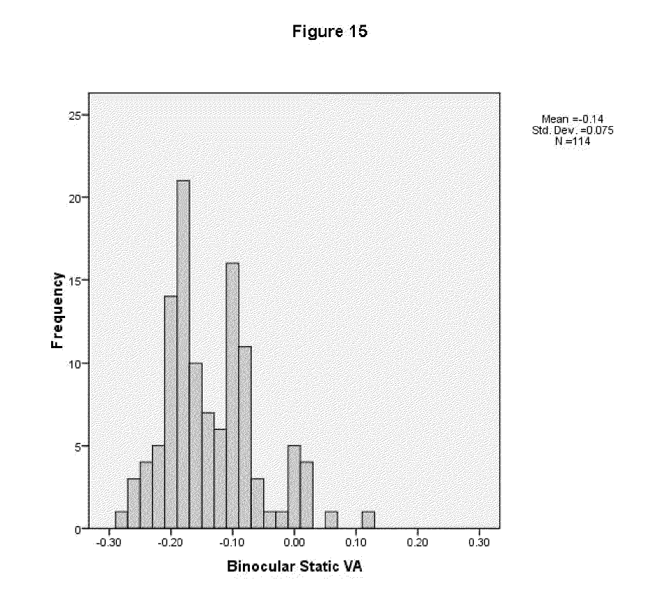

FIG. 14 is a graph illustrating the correlation V1 vs V2 for HL VA;

FIG. 15 is a bar chart of Frequency against Binocular Static VA;

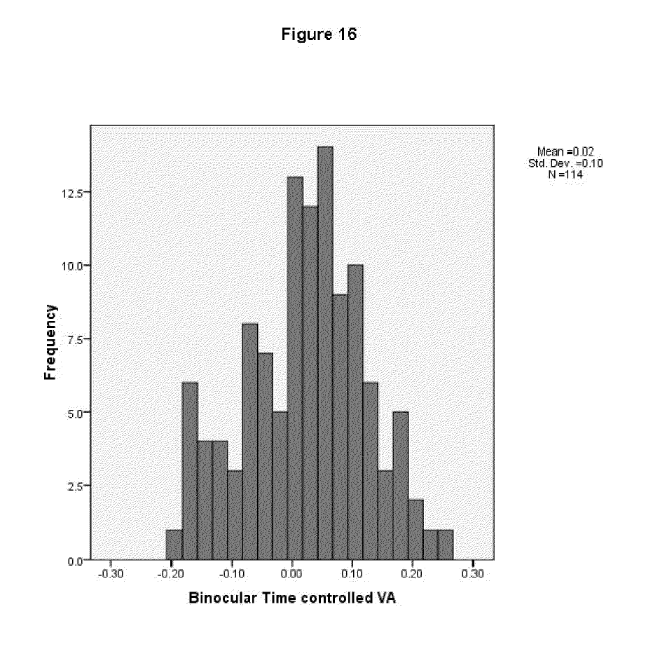

FIG. 16 is a bar chart of Frequency against Binocular Time controlled VA;

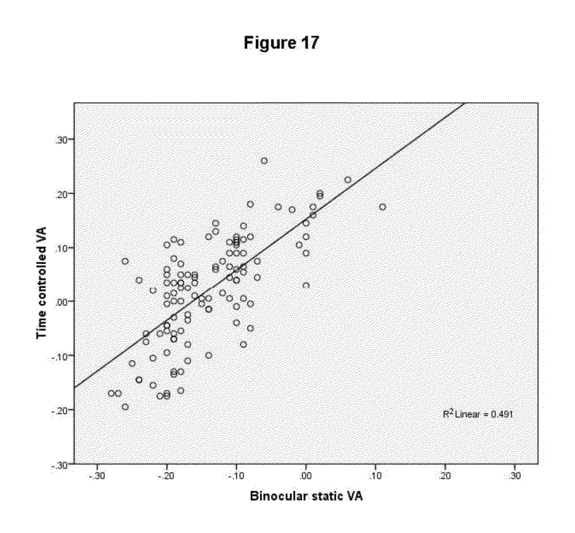

FIG. 17 is a graph of response range; and

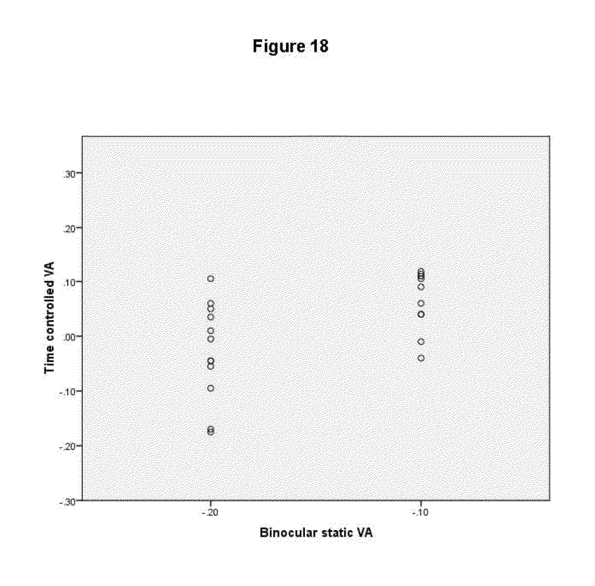

FIG. 18 is a graph of static VA findings

In one arrangement the user will first see the front screen as illustrated in FIG. 1. The user can select between Static Assessments and Time Control Assessments. As illustrated in FIG. 2, the Static Assessments consists of both Visual Acuity tests and Visual Contrast tests. The tests can be customised for various testing distances and screen size from the drop down menus. Subsequent screens are displayed in FIG. 3 to

The Visual Acuity tests can be carried out with BSI letters or Landolt Rings for high and low contrast. In one arrangement the system offers the choice of testing with either 5 or 10 optotypes.

In one example, the computerised charts have the following features:
the change in the minimum angle of resolution between successive chart is constant (0.1 LogMAR) giving similar sensitivity throughout the acuity range;
the series of charts incorporates a wide range of acuities from −8 to +3 and can be used at different viewing distances and therefore, does not truncate artificially higher VA recordings;
unlike standard visual acuity charts, LogMAR charts fulfil the requirements of an interval scale and permit the use of parametric statistics;
the charts are available in two different contrasts, 90% (high) and 10% (low);
the letters are the ten original sloan Letters (D,E,F,H,N,P,R,U,V,Z);
the letter formats are BSI letter format: non-serif 5×5;
the letter spacing is equal to one letter; and
each line is made up of five letters randomly chosen from the Sloan set with, however, three of the five letters easy to read and two more difficult to read. Crowding blocks have been added around the chart to maintain constant letter legibility regardless of the letter position in the line.

The Visual Contrast charts have the following features:
the letters are the ten original sloan Letters (D,E,F,H,N,P,R,U,V,Z);
the letter formats are BSI letter format: non-serif 5×5;
the letter spacing is equal to one letter;
each line is made up of five letters randomly chosen from the sloan set with, however, three of the five letters easy to read and two more difficult to read;
for each line produced a complimentary chart is generated with the five letters not initially selected. Hence, the subjects are tested with the same ten letters at all contrast levels;
the letters in a given chart are all of the same size, the only variable being the chart contrast. For 250 cd/m2, a chart with letters equal to a VA unit of −1.0 (LogMAR+0.1, 6/7.5-20/25) will be used. For 2.5 cd/m2, a chart with letters equal to a VA unit of −4.0 (LogMAR VA +0.4, 6/15-20/50) for a 3 m viewing distance will be used;
17 lines are available in decreasing contrast from 100% to 2.5%; and
crowding blocks have been added around the chart to maintain constant letter legibility regardless of the letter position in the line. The crowding blocks at the end of each line are of the same contrast as the line. The crowding blocks above the charts are 100% contrast and those below the chart are 2.5% contrast.

The letter size at which the testing is to be carried out can be selected from the drop down menus.

The dynamic assessments or “time control assessments” consists of both Time Controlled Visual Acuity and Dynamic Vision Threshold test. The tests can be customized for various testing distances and screen size from the drop down menus.

The Time Controlled Visual Acuity tests can be carried out with either BSI letters or Landolt Rings for high and low contrast. The system offers the choice of testing with a range of letter size from −10 to +4 and a chosen exposure time of each optotype from 100 ms-500 ms.

The Dynamic Vision Threshold test is designed to be carried out with Landolt Rings for High and Low Contrast. The system offers the choice of testing with a range of letter size from −10 to +4. The number of stimuli to be presented to the subject during a single test can be selected using the drop down menu. In one arrangement, the test requires the use of the Joystick for the subject to indicate the position of the gap in the Landolt rings.

The present invention will now be described with reference to the accompanying example. The objective of the investigation was to evaluate the repeatability of the technique using computerized LogMAR visual acuity (VA) Charts and to compare it to conventional LogMar VA measurements.

The visual acuity tests were conducted under room luminance of 250 cd/m² (HL) with high (HC) and low (LC) contrast Landolt C. The assessment of the repeatability of the technique was carried out on ten subjects, each subject was measured on two different days at the same time of the day (V1 and V2). The measurements were carried out with the subjects optimised sphero-cylindrical distance correction. The comparison between the time controlled and conventional LogMar VA was carried out on 114 subjects; the two tests were carried out during a singe visit with the subjects habitual distance correction. The Visual Acuity Charts are illustrated in FIGS. 9 to 11.

The testing conditions were as follows:
Repeatability testing (Time controlled VA) was conducted at normal luminance (250 cd/m²) and 2.5 cd/m² with high and low contrast optotypes;
Comparison testing (time controlled vs Conventional) was conducted at normal luminance (250 cd/m²) and low (2.5 cd/m²) with high and low contrast optotypes; and
The measurements were carried out binocularly with different sets of optotypes presented for each measurement.

The repeatability of the time controlled computerized VA was good and the results are set out in the following tables:

TABLE 1

| Visit 1 | HLHC VA | HLLC VA | HL VA |
|---|---|---|---|
| Mean ± SD | −0.084 ± 0.068 | 0.099 ± 0.074 | 0.008 ± 0.067 |
| [Range] | [−0.16 to +0.05] | [0.00 to +0.21] | [−0.08 to +0.12] |
| Visit 2 | | | |
| Mean ± SD | −0.091 ± 0.081 | +0.100 ± 0.059 | +0.005 ± 0.063 |
| [Range] | [−0.17 to +0.07] | [−0.04 to +0.18] | [−0.11 to +0.10] |

TABLE 2

| V1 vs V2 | HLHC VA | HLLC VA | HL VA |
|---|---|---|---|
| Mean | 0.007 | −0.001 | 0.003 |
| Difference | | | |
| SEM | 0.009 | 0.015 | 0.009 |
| 95% | −0.014 to +0.029 | −0.032 to +0.034 | −0.016 to +0.023 |
| confidence | | | |
| P | 0.444 | 0.947 | 0.717 |

The repeatability for a single measurement is respectively 0.6, 0.9 and 0.5 of a line for HLHC, HLLC and HL.

The study repeatability for a population mean is given in Table 3 for various study samples

TABLE 3

| N | HLHC | HLLC | HL |
|---|---|---|---|
| 15 | 0.15 | 0.23 | 0.14 |
| | (Part of a line) | (Part of a line) | (Part of a line) |
| 20 | 0.12 | 0.20 | 0.12 |
| | (Part of a line) | (Part of a line) | (Part of a line) |
| 25 | 0.11 | 0.18 | 0.11 |
| | (Part of a line) | (Part of a line) | (Part of a line) |

Correlation of visit 1 to visit 2 are illustrated in FIGS. 12 to 14. The Visits 1 and 2 measurements were highly correlated for all testing conditions. The measurements at Visit 2 did not reveal a systematic improvement compared with Visit 1 demonstrating the absence of a learning effect.

The correlations between testing routines are illustrated in FIGS. 15 and 16. The results are set out in Table 4.

TABLE 4

| HLHC Binocular | Static VA | Time Controlled VA |
|---|---|---|
| Mean ± SD | −0.140 ± 0.075 | +0.021 ± 0.100 |
| [Range] | [−0.280 to +0.110] | [−0.195 to +0.260] |

P < 0.001

Difference in mean VA˜one and half line (TCVA=20/20⁻²; SVA=20/15⁺⁴). Response range greater for Time Controlled VA (95% Cl 2 lines) than Static VA (95% Cl 1.5 line). This is illustrated in FIG. 17.

There was only partial correlation between static VA and Time Controlled VA. Static VA findings explained only 49% of the Time controlled VA. This is illustrated in FIG. 18. For identical static VA very different Time Controlled VA

Static VA=−0.10 Time controlled VA −0.04 to +0.12
Static VA=−0.20 Time controlled VA −0.18 to +0.11

The repeatability of the Time Controlled Computerised VA was good and the results were highly correlated between the two visits. The findings were different for conventional LogMAR VA and Time controlled VA. The novel time controlled computerized visual acuity routine showed a greater ability at differentiating between subjects.

This example showed that the measurement of the time controlled visual acuity using computerized Landolt optotypes is a reliable and highly sensitive technique. This technique produces testing conditions which are closet to every day visual tasks when compared with the prior art.

1. A method of operating a data processing apparatus for testing visual acuity and/or visual contrast, the method comprising displaying symbols on a display device, the symbols displayed having luminance, colour and contrast, varying the luminance, colour and/or contrast or any one or combination of luminance, colour and/or contrast of the symbols displayed on the display device; and varying the time period for displaying the symbols.

2. A method of testing visual acuity and/or visual contrast, the method comprising displaying symbols on a display device of a data processing apparatus, the symbols displayed having luminance, colour and contrast, varying the luminance, colour and/or contrast or any one or combination of luminance, colour and/or contrast of the symbols displayed on the display device; and varying the time period for displaying the symbols; and observing a patient response to the varying luminance, colour and/or contrast and the varying time period.

3. A system for testing visual acuity and/or contrast, the system comprising a data processing apparatus and a display device, the data processing apparatus configured to display symbol on the display device, the symbols displayed having luminance, colour and contrast; wherein said luminance, colour and/or contrast or any one or combination of luminance, colour and/or contrast of the symbols when displayed on said screen can be varied; and the time period for displaying the symbols can be varied.

4. The method according to claim 1 wherein the time period for displaying the symbols is the period for which the symbols are displayed on the monitor.

5. The method according to claim 1, wherein the time period for displaying the symbols is the period between display of successive symbols on the monitor.

6. The method according to claim 1, wherein the luminance, colour and/or contrast can be varied to represent environmental conditions.

7. The method or system according to claim 6, wherein the environmental conditions are one of or any combination of daytime, night time, indoor and/or outdoor conditions.

8. The method or system according to claim 6, wherein the luminance can be varied from 1000 cd/m² to 2.5 cd/m².

9. The method or system according to claim 6, wherein a luminance of 250 cd/m² represents daytime conditions, a luminance of 50 cd/m² represents indoor conditions, or a luminance of 2.5 cd/m² represents night time conditions.

10. The method or system according to claim 6, wherein the luminance can be varied by neutral density filters.

11. The method or system according to claim 6, wherein the contrast is varied from 99.9% to 0.1%, or from 90% to 10%.

12. The method according to any one of claims 1, wherein the time period can be varied from 10 ms to being permanently on.

13. The method according to any one of claims 1 wherein the time period is of the order of 200-800 ms.

14. The method according to any one of claims 1 wherein the time period is 300 ms.

15. The method according to any one of claims 1 wherein the symbol is a user defined symbol.

16. The method or system according to claim 15, wherein the user defined symbol is an image of an object.

17. The method or system according to claim 15, wherein the user defined symbol is an optotype.

18. The method according to any one of claims 1 wherein the size of the symbol displayed can be varied.

19. The method according to any one of claims 1 wherein the symbol can be displayed on a user defined background.

20. The method according to any one of claims 1 wherein the visual contrast is for black and white, monochromatic or polychromatic displays

21. The method according to any one of claims 1 wherein the method or system includes combinations of different distances and/or different directions of gaze.

22. A program for a computer arranged to implement the method of claims 1.
